(19) United States
(12) Patent Application Publication
(10) Pub. No.: US 2017/0328360 A1
(43) Pub. Date: Nov. 16, 2017

(54) APPARATUS, SYSTEM AND METHOD OF CONTROLLING ELECTRIC SUBMERSIBLE PUMP BASED ON DEMAND RESPONSE

(71) Applicant: GE Lighting Solutions, LLC, East Cleveland, OH (US)

(72) Inventor: Scott Mordin HOYTE, Edmond, OK (US)

(21) Appl. No.: 15/262,511

(22) Filed: Sep. 12, 2016

Related U.S. Application Data
(60) Provisional application No. 62/334,616, filed on May 11, 2016.

(51) Int. Cl. F04B 49/06; G05F 1/66; F04B 47/06; F04B 49/20; G05D 7/06

(52) U.S. Cl. CPC F04B 49/065; F04B 49/20; G05D 7/0676; F04B 47/06; G05F 1/66; F04B 2203/0209; G05B 2219/43193

(57) ABSTRACT

An apparatus, system and method of controlling one or more electric submersible pumps (ESPs) based on demand response to an electrical power grid. The ESPs may either be turned off, or operated at a slower speed to allow for an operator of an electrical power grid to shed load during peak times without impacting other assets on the electrical power grid.

### CROSS-REFERENCE TO RELATED APPLICATIONS

The present application claims priority to U.S. Provisional Patent Publication No. 62/334,616 (filed on May 11, 2016), which is hereby incorporated by reference in its entirety.

### TECHNICAL FIELD

Embodiments generally relate to an apparatus, system and method of controlling one or more electric submersible pumps (ESPs) based on demand response. The ESPs may either be turned off, or operated at a slower speed to allow for an operator of an electrical power grid to shed load during peak times without impacting other assets on the electrical power grid.

### BACKGROUND

Electric Submersible Pumps (ESPs), which are the primary producer or oil in artificially lifted wells, account for a large electric load in an electrical power grid. When the electrical power grid enters a situation where demand activity is considered non-peak, i.e., demand exceeds capacity load, load is needed to be shed in order to avoid frequency droop and ultimately instability of the grid.

### BRIEF DESCRIPTION OF THE DRAWINGS

The various advantages of embodiments will become apparent to one skilled in the art by reading the following specification and appended claims, and by referencing the following drawings, in which:

FIG. 1 illustrates an example of a system to control an array of electric submersible pumps operatively connected to an electric power grid, in accordance with embodiments.

FIG. 2 illustrates an example of a system to control an array of electric submersible pumps operatively connected to an electric power grid, in accordance with embodiments

FIG. 3 illustrates a block diagram of an apparatus that includes the control module, in accordance with embodiments.

FIG. 4 illustrates a flow chart of a method of controlling an array of electric submersible pumps operatively connected to a system, in accordance with embodiments.

### DETAILED DESCRIPTION

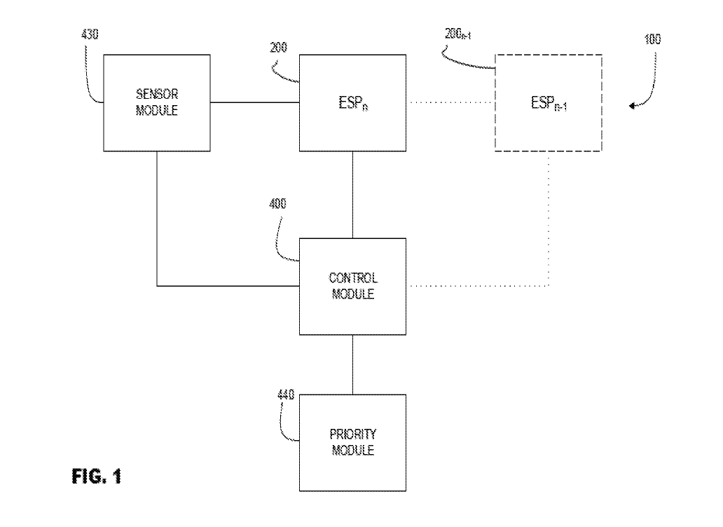

As illustrated in FIGS. 1 through 3, a system 100, in accordance with embodiments, to control an array, group, or plurality of electric submersible pumps 200 of number N. The electric submersible pumps 200 are operatively connected to a system, such as, for example, an electric power grid 300. The electric submersible pumps 200 may be driven by a variable frequency drive (VSD) 500, and are configured to operate at a variable operating speed.

In accordance with embodiments, the system 100 includes a control module 400 to control of the electric submersible pumps 200. The control module 400 may control operation of the electric submersible pumps 200 either directly via, for example, a switchboard.

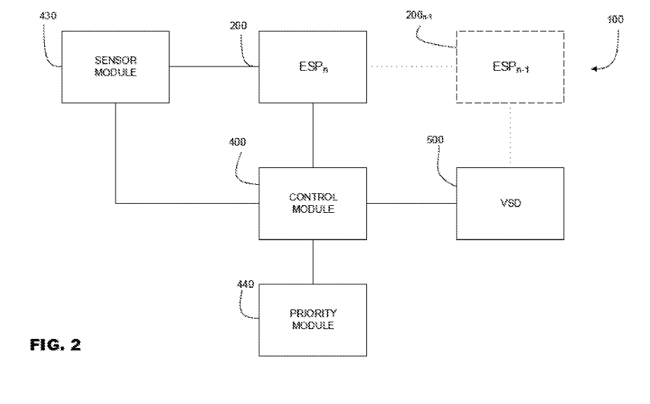

As illustrated in FIG. 2, the control module 400 may control operation of the electric submersible pumps 200 indirectly via the VFD 500.

In accordance with embodiments, the system 100 may also include a sensor module 430 operatively connected to the control module 400, and a priority module 440, operatively connected indirectly to the control module 400 via the sensor module 430, or alternatively, directly to the control module 400. The sensor module 430 may include one or more sensors to detect a well performance of an electric submersible pump 200 operating at the well. The priority module 440 may include one or more prioritizers to then define a priority of the electric submersible pumps 200 based on the detected well performance. The control module 400 is to then selectively identify and control operation of one or more of the electric submersible pumps 200 based on the prioritization of the electric submersible pumps 200.

The sensor module 430 and the priority module 440, in accordance with embodiments, may be implemented in the control module 400. Alternatively, the sensor module 430 and the priority module 440 may be implemented external to the control module 400.

The sensors of the sensor module 430, in accordance with embodiments, may be implemented directly at a respective one of the electric submersible pumps 200. Alternatively, the sensors of the sensor module 430 may be implemented at a location external to the electric submersible pumps 200.

In accordance with embodiments, when the detected demand status comprises a peak activity of electric power from the grid 300, the control module 400 is to selectively transmit a control signal to the selected at least one electric submersible pump 200. Receipt of the control signal by the selected at least one electric submersible pump 200 is to cause the selected at least one the electric submersible pump 200 to operate at a speed less than a current, detected operating speed that may be also detected by the control module 400. Alternatively, the control module 400 may selectively transmit a control signal to deactivate the selected electric submersible pump(s) 200. In this way, when the grid 300 enters a situation in which demand exceeds capacity load, i.e., during peak times, load may be automatically shed load by reducing the operating speed, or turning off, on or more of the electric submersible pumps 200 that is selected on a basis of well performance. This also serves to reduce electrical energy demand.

Once the detected demand status comprises a non-peak activity of electric power from the grid 300, the control module 400 may then reactivate the previously deactivated electric submersible pump(s) 200.

In accordance with embodiments, when the detected demand status comprises a non-peak demand activity of electric power from the grid 300, the control module 400 is to selectively transmit a control signal to the selected at least one electric submersible pump 200. Receipt of the control signal by the selected at least one electric submersible pump 200 is to cause the selected at least one electric submersible pump to operate at a speed greater than a current, detected operating speed. In this way, when the grid 300 enters a situation in which demand is less than capacity load, i.e., during non-peak times, load may be automatically increased by increasing the operating speed of one or more of the electric submersible pumps 200 that is selected on a basis of well performance. This also allows for a trade off in power consumption in order to maintain production.

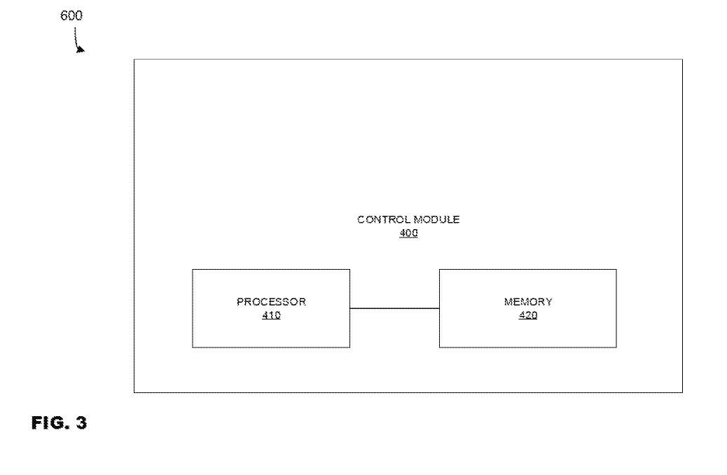

As illustrated in FIG. 3, an apparatus 600 in accordance with embodiments may include control module 400 having at least one processor 410 and a least one computer readable storage medium 420 a machine- or computer-readable storage medium, such as, for example, random access memory (RAM), read only memory (ROM), programmable ROM (PROM), firmware, flash memory, etc. The computer readable storage medium 420 is configured to store a set of instructions which, if executed by the control module 400, cause the control module 400 to detect a demand status of electric power, and selectively control operation of at least one electric submersible pump in the array based on the detected demand status of electric power from the electric power grid 300.

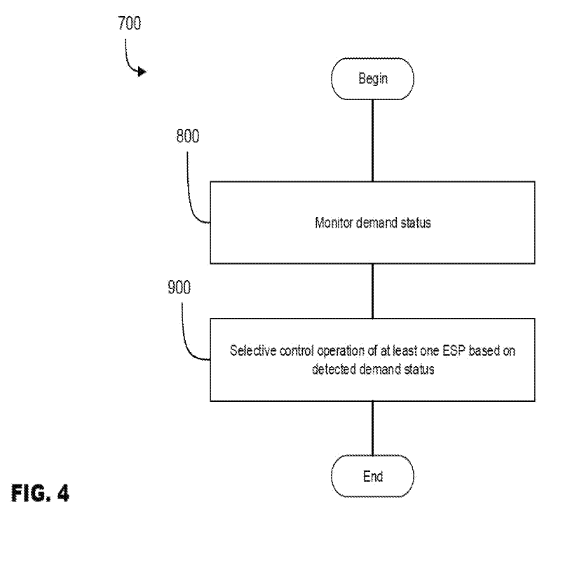

As illustrated in FIG. 4, a method 700 is provided for controlling an array of electric submersible pumps operatively connected to an electrical system, such as, for example, electric power grid.

In accordance with embodiments, the method 700 may be implemented as a module or related component in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 700 may be written in any combination of one or more programming languages, including an object oriented programming language such as Java, Smalltalk, C++ or the like and conventional procedural programming languages, such as the “C” programming language or similar programming languages.

Illustrated processing block 800 provides for monitoring a demand status of electric power from the grid. Block 800, may, for example, monitor a current economic analysis of a price of oil. Block 800, may, for example, monitor an economic evaluation of a capacity payment. Block 800, may, for example, monitor a current price of electricity. Block 800, may, for example, monitor oil production. Block 800 may, in accordance with embodiments, monitor, collectively, a least one of the above-noted events.

Illustrated processing block 900 provides for selectively controlling operation of at least one electric submersible pump in the array based on the detected demand status. Block 900 may, for example, detect a well performance of each electric submersible pump in the array. Block 900 may then, for example, prioritize the electric submersible pumps based on the detected well performance. Block 900 may then, for example, select at least one electric submersible pump in the array based on the prioritization. Block 900 may then, for example, control the operating speed of the selected at least one electric submersible pump.

When the detected demand status comprises a non-peak demand activity of electric power, block 900 may, for example, selectively control the operating speed of the selected electric submersible pump(s) by operating the selected electric submersible pump(s) at a speed greater than a current operating speed of the at least one electric submersible pump.

On the other hand, when the detected demand status comprises a peak demand activity of electric power, block 900 may, for example, selectively control the operating speed of the selected electric submersible pump(s) by operating the selected electric submersible pump(s) at a speed lesser than a current operating speed of the respective electric submersible pump(s). Alternatively, block 900 may, for example, selectively control the operating speed of the selected electric submersible pump(s) by deactivating (i.e., turning off) the selected electric submersible pump(s).

Illustrated processing block 900 may, for example, subsequently reactivate the previously deactivated electric submersible pump(s), when the detected demand status comprises a non-peak demand activity of electric power.

In accordance with embodiments, an economic analysis of the price of oil, and the price that will be given to reduce the load enables prioritization of which wells will be selected to shed load. Additionally, during off peak times on or more of the electric submersible pumps may be sped up to make up lost production when previously slowed down.

Embodiments may include a real time economic evaluation of the capacity payment, price of electricity, compensation for reducing load, price of oil, oil production (and loss thereof), trading off what an operator of the electric submersible pumps might get as a benefit for providing such information to a grid operator.

Embodiments facilitate an ability to supply massive demand response multi-MW scale, without impact to the general public, and with the potential of shifting the load to non-peak grid activities to maintain oil production.

Embodiments may also utilize VFDs and demand response SW to automatically set the speed of the electric submersible pumps (either slower or faster) to maintain grid stability and oil production.

Although embodiments provide for automatic control of one or more electric submersible pumps based on demand response, embodiments are not limited thereto. For example, automatic control of one or more of the electric submersible pumps may occur manually by an operator, for example, in order to minimize electricity cost by producing more in instances in which power cost are determined to be low.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### Additional Notes and Examples

Example 1 may include an apparatus to control an array of electric submersible pumps operatively connected to an electric power grid, the apparatus comprising: a control module having a processor and a computer readable storage medium to store a set of instructions which, if executed by the control module, cause the control module to detect a demand status of electric power, and selectively control operation of at least one electric submersible pump in the array based on the detected demand status of electric power.

Example 2 may include the apparatus of Example 1, further comprising: a sensor module, operatively connected to the control module, to detect a well performance of each electric submersible pump in the array; and a priority module, operatively connected to the sensor module, to prioritize the electric submersible pumps based on the detected well performance.

Example 3 may include the apparatus of Example 2, wherein selective control of the operation of the at least one electric submersible pump comprises selecting the at least one electric submersible pump based on the prioritization of the electric submersible pumps.

Example 4 may include the apparatus of Example 3, wherein when the detected demand status comprises a peak activity of electric power, the control module is to selectively transmit a control signal to the selected at least one electric submersible pump in the array which causes the selected at least one electric submersible pump to operate at a speed less than a current operating speed.

Example 5 may include the apparatus of Example 3, wherein when the detected demand status comprises a non-peak demand activity of electric power, the control module is to selectively transmit a control signal to the selected at least one electric submersible pump which causes the selected at least one electric submersible pump to operate at a speed greater than a current operating speed.

Example 6 may include the apparatus of Example 3, wherein when the detected demand status comprises a peak demand activity of electric power, the control module is to selectively transmit a control signal to the selected at least one electric submersible pump which causes a deactivation of the selected at least one electric submersible pump.

Example 7 may include the apparatus of Example 6, wherein when the detected demand status comprises a non-peak demand activity of electric power, the control module is to selectively transmit a control signal to the selected at least one electric submersible pump which causes a reactivation of the previously deactivated selected at least one electric submersible pump.

Example 8 may include a method of controlling an array of electric submersible pumps operating at a variable operating speed, and which are connected to a system, the method comprising: monitoring a demand status of electric power from the system; and selectively controlling operation of at least one electric submersible pump in the array based on the detected demand status.

Example 9 may include the method of Example 8, wherein selectively controlling operation of at least one electric submersible pump in the array comprises: detecting a well performance of each electric submersible pump in the array; prioritizing the electric submersible pumps based on the detected well performance; and selecting at least one electric submersible pump in the array based on the prioritization.

Example 10 may include the method of Example 9, wherein selectively controlling the operating speed of the at least one electric submersible pump comprises operating the selected at least one electric submersible pump at a speed greater than a current operating speed of the at least one electric submersible pump, when the detected demand status comprises a non-peak demand activity of electric power.

Example 11 may include the method of Example 9, wherein selectively controlling the operating speed of the at least one electric submersible pump comprises operating the selected at least one electric submersible pump at a speed lesser than a current operating speed of the at least one electric submersible pump, when the detected demand status comprises a peak demand activity of electric power.

Example 12 may include the method of Example 9, wherein selectively controlling the operating speed of the at least one electric submersible pump comprises deactivating the selected at least one electric submersible pump, when the detected demand status comprises a peak demand activity of electric power.

Example 13 may include the method of Example 12, wherein selectively controlling the operating speed of the at least one electric submersible pump comprises reactivating the previously deactivated selected at least one electric submersible pump, when the detected demand status comprises a non-peak demand activity of electric power.

Example 14 may include a computer readable storage medium comprising a set of instructions which, if executed by control module, cause a device to: monitor a demand status of electric power from a system; and selectively control operation, based on the detected demand status, of at least one electric submersible pump in an array of electric submersible pumps operatively connected to the system.

Example 15 may include the computer readable storage medium of Example 14, wherein the instructions, when executed, cause the device to: detect a well performance of each electric submersible pump in the array; prioritize the electric submersible pumps based on the detected well performance; and select at least one electric submersible pump in the array based on the prioritization.

Example 16 may include the computer readable storage medium of Example 15, wherein the instructions, when executed, cause the device to operate the selected at least one electric submersible pump at an operating speed greater than a current operating speed of the at least one electric submersible pump, when the detected demand status comprises a non-peak demand activity of electric power from the system.

Example 17 may include the computer readable storage medium of Example 15, wherein the instructions, when executed, cause the device to operate the selected at least one electric submersible pump at an operating speed lesser than a current operating speed of the at least one electric submersible pump, when the detected demand status comprises a peak demand activity of electric power from the system.

Example 18 may include the computer readable storage medium of Example 15, wherein the instructions, when executed, cause the device to deactivate the selected at least one electric submersible pump, when the detected demand status comprises a peak demand activity of electric power from the system.

Example 19 may include the computer readable storage medium of Example 15, wherein the instructions, when executed, cause the device to reactivate the previously deactivated at least one electric submersible pump, when the detected demand status comprises a non-peak demand activity of electric power from the system.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so forth”, “and so on”, or “etc.” may mean any combination of the listed terms as well any combination with other terms.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. An apparatus to control an array of electric submersible pumps operable at a variable operating speed, and which are operatively connected to an electric power grid, the apparatus comprising:
a control module having a processor and a computer readable storage medium to store a set of instructions which, if executed by the control module, cause the control module to detect a demand status of electric power, and selectively control operation of at least one electric submersible pump in the array based on the detected demand status of electric power.

2. The apparatus of claim 1, further comprising:
a sensor module, operatively connected to the control module, to detect a well performance of each electric submersible pump in the array; and
a priority module, operatively connected to the sensor module, to prioritize the electric submersible pumps based on the detected well performance.

3. The apparatus of claim 2, wherein selective control of the operation of the at least one electric submersible pump comprises selecting the at least one electric submersible pump based on the prioritization of the electric submersible pumps.

4. The apparatus of claim 3, wherein when the detected demand status comprises a peak activity of electric power, the control module is to selectively transmit a control signal to the selected at least one electric submersible pump in the array which causes the selected at least one electric submersible pump to operate at a speed less than a current operating speed.

5. The apparatus of claim 3, wherein when the detected demand status comprises a non-peak demand activity of electric power, the control module is to selectively transmit a control signal to the selected at least one electric submersible pump which causes the selected at least one electric submersible pump to operate at a speed greater than a current operating speed.

6. The apparatus of claim 3, wherein when the detected demand status comprises a peak demand activity of electric power, the control module is to selectively transmit a control signal to the selected at least one electric submersible pump which causes a deactivation of the selected at least one electric submersible pump.

7. The apparatus of claim 6, wherein when the detected demand status comprises a non-peak demand activity of electric power, the control module is to selectively transmit a control signal to the selected at least one electric submersible pump which causes a reactivation of the previously deactivated selected at least one electric submersible pump.

8. A method of controlling an array of electric submersible pumps operating at a variable operating speed, and which are connected to a system, the method comprising:
monitoring a demand status of electric power; and
selectively controlling operation of at least one electric submersible pump in the array based on the detected demand status.

9. The method of claim 8, wherein selectively controlling operation of at least one electric submersible pump in the array comprises:
detecting a well performance of each electric submersible pump in the array;
prioritizing the electric submersible pumps based on the detected well performance; and
selecting at least one electric submersible pump in the array based on the prioritization.

10. The method of claim 9, wherein selectively controlling the operating speed of the at least one electric submersible pump comprises operating the selected at least one electric submersible pump at a speed greater than a current operating speed of the at least one electric submersible pump, when the detected demand status comprises a non-peak demand activity of electric power.

11. The method of claim 9, wherein selectively controlling the operating speed of the at least one electric submersible pump comprises operating the selected at least one electric submersible pump at a speed lesser than a current operating speed of the at least one electric submersible pump, when the detected demand status comprises a peak demand activity of electric power.

12. The method of claim 9, wherein selectively controlling the operating speed of the at least one electric submersible pump comprises deactivating the selected at least one electric submersible pump, when the detected demand status comprises a peak demand activity of electric power.

13. The method of claim 12, wherein selectively controlling the operating speed of the at least one electric submersible pump comprises reactivating the previously deactivated selected at least one electric submersible pump, when the detected demand status comprises a non-peak demand activity of electric power.

14. A computer readable storage medium comprising a set of instructions which, if executed by control module, cause a device to:
monitor a demand status of electric power from a system; and
selectively control operation, based on the detected demand status, of at least one electric submersible pump in an array of electric submersible pumps operatively connected to the system.

15. The computer readable storage medium of claim 14, wherein the instructions, when executed, cause the device to:
detect a well performance of each electric submersible pump in the array;
prioritize the electric submersible pumps based on the detected well performance; and
select at least one electric submersible pump in the array based on the prioritization.

16. The computer readable storage medium of claim 15, wherein the instructions, when executed, cause the device to operate the selected at least one electric submersible pump at an operating speed greater than a current operating speed of the at least one electric submersible pump, when the detected demand status comprises a non-peak demand activity of electric power from the system.

17. The computer readable storage medium of claim 15, wherein the instructions, when executed, cause the device to operate the selected at least one electric submersible pump at an operating speed lesser than a current operating speed of the at least one electric submersible pump, when the detected demand status comprises a peak demand activity of electric power from the system.

18. The computer readable storage medium of claim 15, wherein the instructions, when executed, cause the device to deactivate the selected at least one electric submersible pump, when the detected demand status comprises a peak demand activity of electric power from the system.

19. The computer readable storage medium of claim 15, wherein the instructions, when executed, cause the device to reactivate the previously deactivated at least one electric submersible pump, when the detected demand status comprises a non-peak demand activity of electric power from the system.
